(19) United States
(12) Patent Application Publication
(10) Pub. No.: US 2002/0189051 A1
(43) Pub. Date: Dec. 19, 2002

(54) Caster brake assembly

(76) Inventors: Richard M. Holbrook, Altadena, CA (US); Darren M. Mark, Valencia, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/163,267

(22) Filed: Jun. 5, 2002

Related U.S. Application Data
(60) Provisional application No. 60/296,251, filed on Jun. 5, 2001.
(60) Provisional application No. 60/296,430, filed on Jun. 5, 2001.

(51) Int. Cl. B60B 33/00

(52) U.S. Cl. 16/18 R

(57) ABSTRACT

The present invention provides a caster assembly having at least one caster wheel attached to a wheel axis that is, in turn, attached to a caster body having an attachment assembly. A cogwheel is attached to each of the at least one caster wheels, wherein each cogwheel has a plurality of radially outwardly extending cogs and a plurality of cog recesses, wherein each pair of adjacent cogs defines a cog recess therebetween. A brake lever arm is moveably attached to the attachment assembly, such that the brake lever arm is moveable between a locked position, wherein the brake lever arm prevents a rotation of the at least one caster wheel and an unlocked position, wherein the brake lever arm does not prevent a rotation of the at least one caster wheel, the brake lever arm having a protrusion for engagement with a corresponding one of the plurality of cog recesses, such that when the protrusion is engaged with the corresponding one of the plurality of cog recesses, the brake lever arm is in the locked position and when the protrusion is not engaged with the corresponding one of the plurality of cog recesses, the brake lever arm is in the unlocked position.

### CROSS-REFERENCE TO RELATED APPLICATION(S)

This application claims priority under 35 U.S.C. §119(e) to U.S. Provisional Application Ser. No. 60/296,251, filed on Jun. 5, 2001 and to U.S. Provisional Application Ser. No. 60/296,430, also filed on Jun. 5, 2001.

The disclosure of U.S. patent application Ser. No. ______ (attorney docket number H367-48518), entitled “CASTER ASSEMBLY HAVING AN INTERCHANGEABLE CASTER CAP”, filed on even date herewith is incorporated herein in full by reference as if stated in full herein.

Reference is made to U.S. Design patent application Ser. No. 29/133,111 (“Caster”) filed Nov. 22, 2000.

### FIELD OF THE INVENTION

The present invention is directed to a caster assembly, such as a twin wheel caster, for use with furniture, such as a chair. More particularly, the present invention is directed to a caster assembly having a brake assembly.

### BACKGROUND OF THE INVENTION

Casters are typically mounted to the legs or footings of furniture pieces to provide for ease of mobility of the furniture pieces. Casters typically comprise either two wheels (commonly referred to as twin wheel casters) or a single wheel (commonly referred to as single wheel casters). FIGS. 1-2 and FIGS. 3-4 show twin wheel and single wheel casters, respectively, that do not contain a brake assembly. FIGS. 1 and 2 show a twin wheel caster 1, comprising a caster body 2, a first wheel 3, and a second wheel 4. As depicted in FIG. 2, the wheels 3 and 4 are rotatably mounted on opposing ends of an axle 6, which is mounted in a bore of the caster body 2 and extends outwardly from opposite sides of the bore.

FIGS. 3 and 4 show a single wheel caster 5, comprising a caster body 2 and a first wheel 3. The wheel 3 is rotatably mounted on an axle 7, which is mounted in a bore of the caster body 2 and extends outwardly from the bore and is covered by an axle cap 8.

It is sometimes desirable for a furniture piece to alternate between stationary and mobile states. Mounting casters that have braking assemblies enables such furniture pieces to alternate between stationary and mobile states.

Casters having brake assemblies are well known in the art. However, current caster brake assemblies often include braking mechanisms that are difficult to activate, difficult to release and/or fail to effectively brake the caster wheels, thereby failing to preserve the furniture piece in a stationary state.

### SUMMARY OF THE INVENTION

The present invention provides a caster assembly comprising at least one caster wheel; a wheel axis attached to the at least one caster wheel; a caster body having an attachment assembly, wherein the wheel axis attached to the attachment assembly; a cogwheel attached to each of the at least one caster wheels, wherein each cogwheel has a plurality of radially outwardly extending cogs and a plurality of cog recesses, wherein each pair of adjacent cogs defines a cog recess therebetween; and a brake lever arm moveably attached to the attachment assembly, such that the brake lever arm is moveable between a locked position, wherein the brake lever arm prevents a rotation of the at least one caster wheel and an unlocked position, wherein the brake lever arm does not prevent a rotation of the at least one caster wheel, the brake lever arm having a protrusion for engagement with a corresponding one of the plurality of cog recesses, such that when the protrusion is engaged with the corresponding one of the plurality of cog recesses, the brake lever arm is in the locked position and when the protrusion is not engaged with the corresponding one of the plurality of cog recesses, the brake lever arm is in the unlocked position.

### BRIEF DESCRIPTION OF THE DRAWINGS

These and other features of the present invention are more fully set forth in the following description of exemplary embodiments of the invention. The description is presented with reference to the accompanying drawings in which:

FIG. 1 shows a perspective view of a twin wheel caster with no brake assembly;

FIG. 2 shows a top view of the twin wheel caster with no brake assembly of FIG. 1;

FIG. 3 shows a side view of a single wheel caster with no brake assembly;

FIG. 4 shows a top view of the single wheel caster with no brake assembly of FIG. 3;

FIG. 5 shows a perspective view of a twin wheel caster having a brake assembly according to the present invention;

FIG. 6 shows a top view of the twin wheel caster of FIG. 5;

FIG. 7 shows a side view of a single wheel caster having a brake assembly according to the present invention;

FIG. 8 shows a top view of the single wheel caster of FIG. 7;

FIG. 9 shows a side view of a twin wheel caster having a brake assembly according to the present invention, wherein the brake lever is in a brake-activated (locked) position;

FIG. 10 shows a side view of the twin wheel caster of FIG. 9, wherein the brake lever is in a brake-released (unlocked) position;

FIG. 11a shows a top exploded perspective view of a twin wheel caster according to the present invention;

FIG. 11b shows another top exploded perspective view of the twin wheel caster according to the present invention;

FIG. 12a shows an bottom exploded perspective view of the twin wheel caster according to the present invention; and

FIG. 12b shows another bottom exploded perspective view of the twin wheel caster according to the present invention.

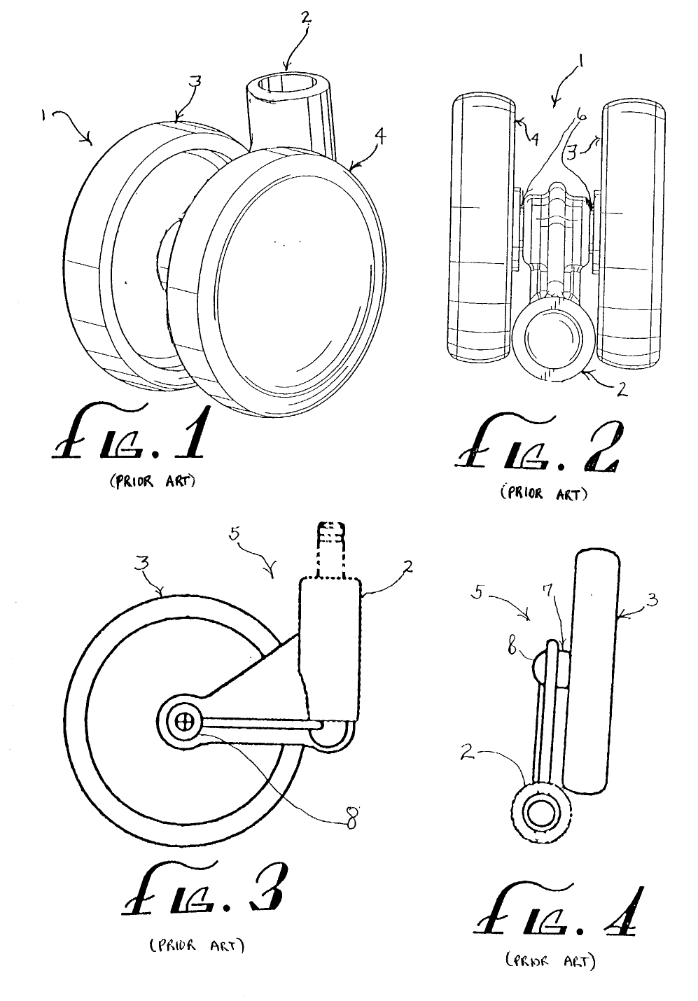

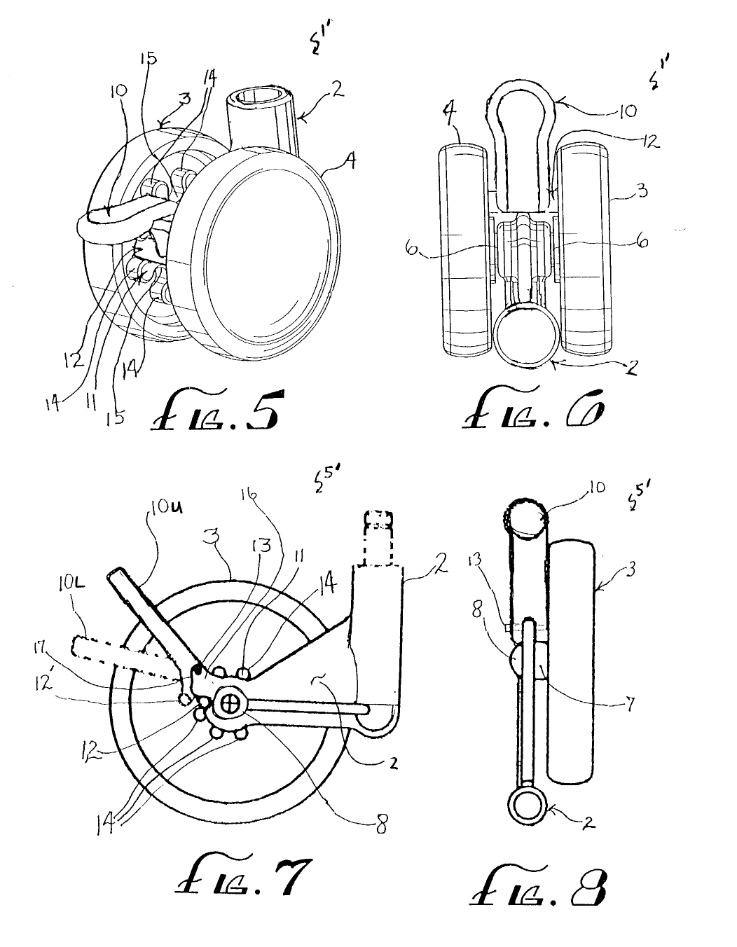

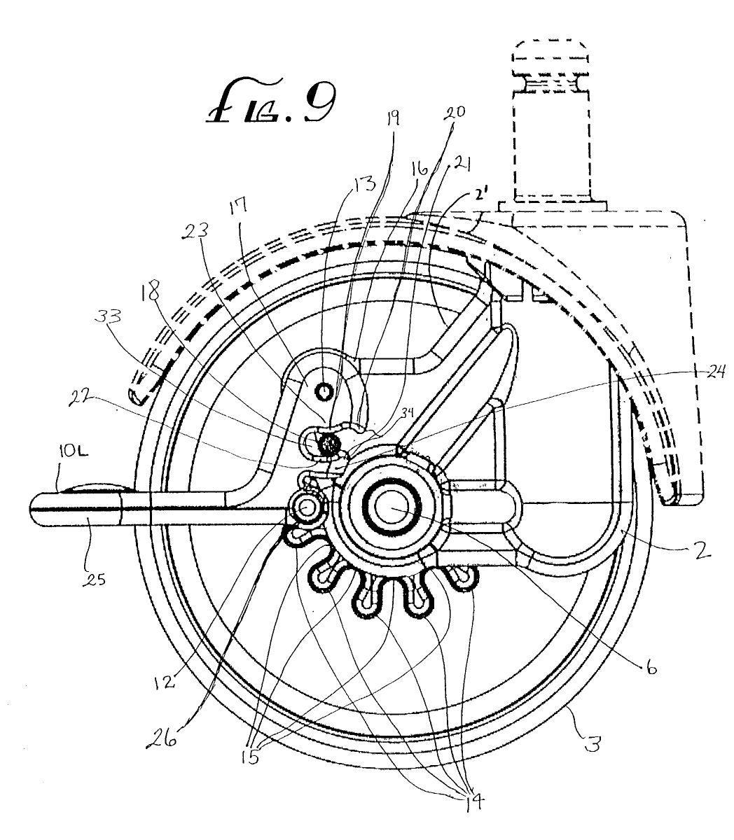

### DETAILED DESCRIPTION OF THE INVENTION

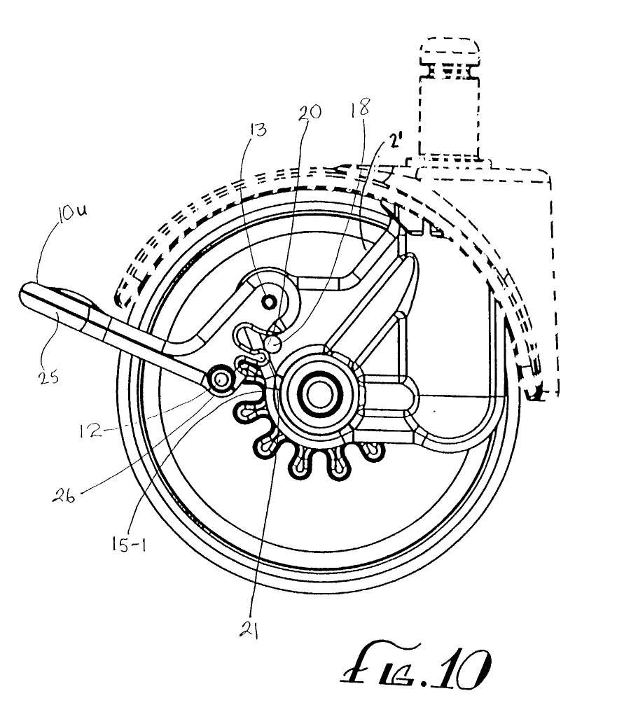

FIGS. 5-6 and 7-8 show a twin wheel and a single wheel caster, respectively, each having a brake assembly according to the present invention. FIGS. 5 and 6 show a twin wheel caster 1′, comprising a caster body 2, a first wheel 3 and a second wheel 4. As depicted in FIG. 6, the wheels 3 and 4 are rotatably mounted on opposing ends of an axle 6, which is mounted in a bore of the caster body 2 and extends outwardly opposite sides of the bore.

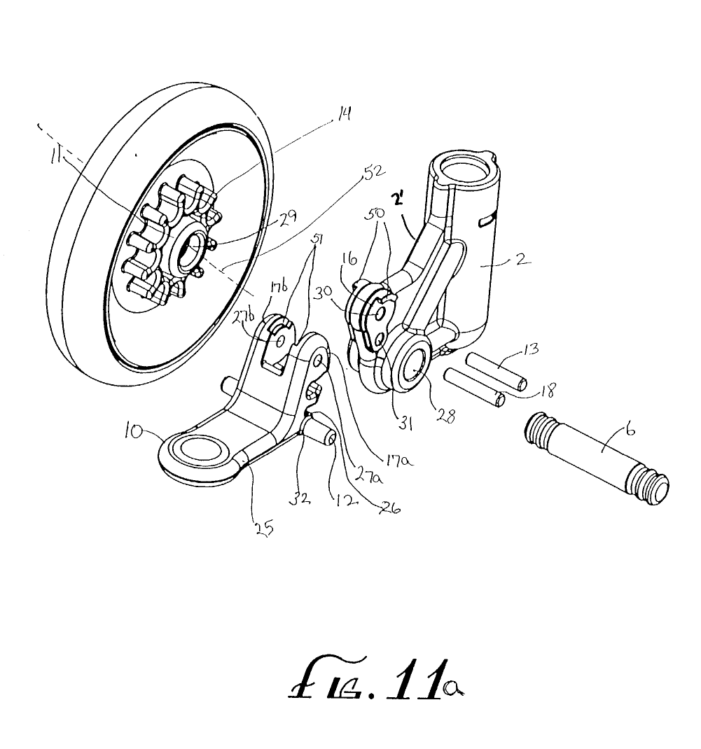

FIGS. 7 and 8 show a single wheel caster 5′, comprising a caster body 2 and a first wheel 3. The wheel 3 is rotatably mounted on an axle 7, which is mounted in a bore of the caster body 2 and extends outwardly from the bore and is covered by an axle cap 8.

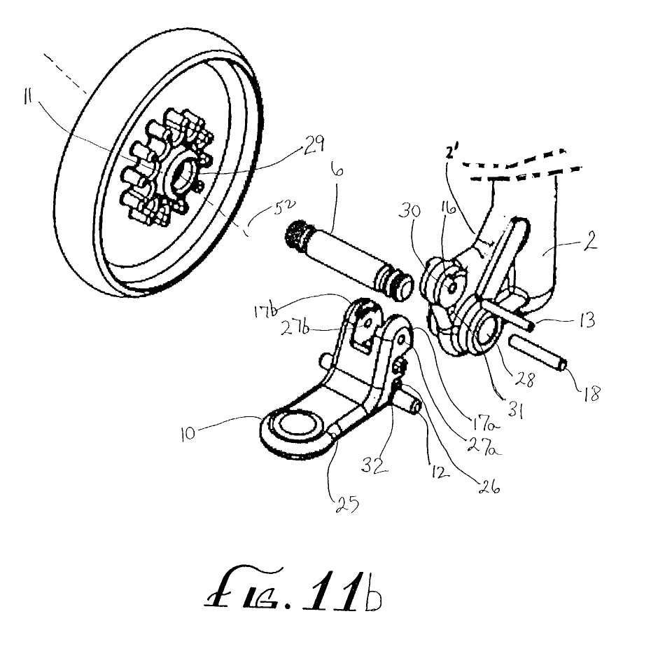

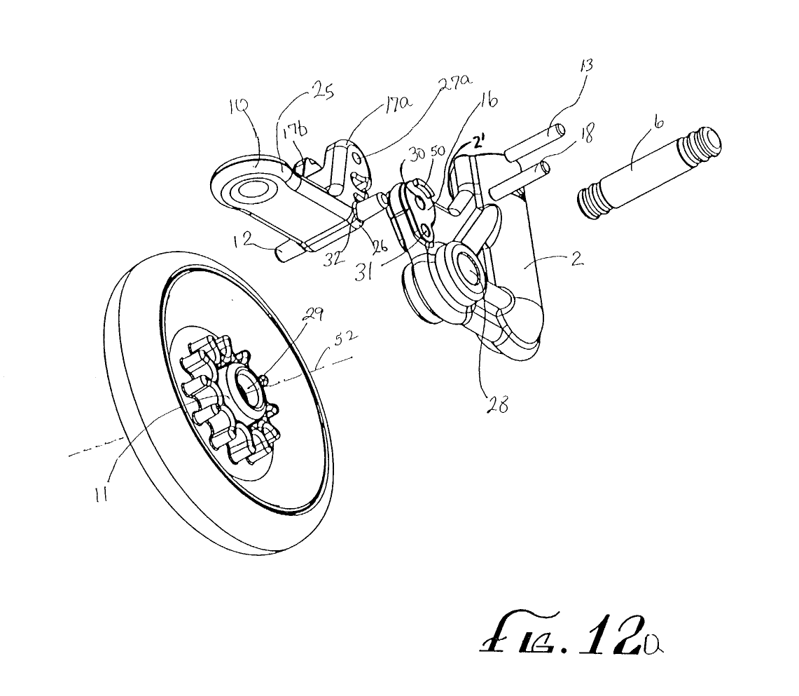

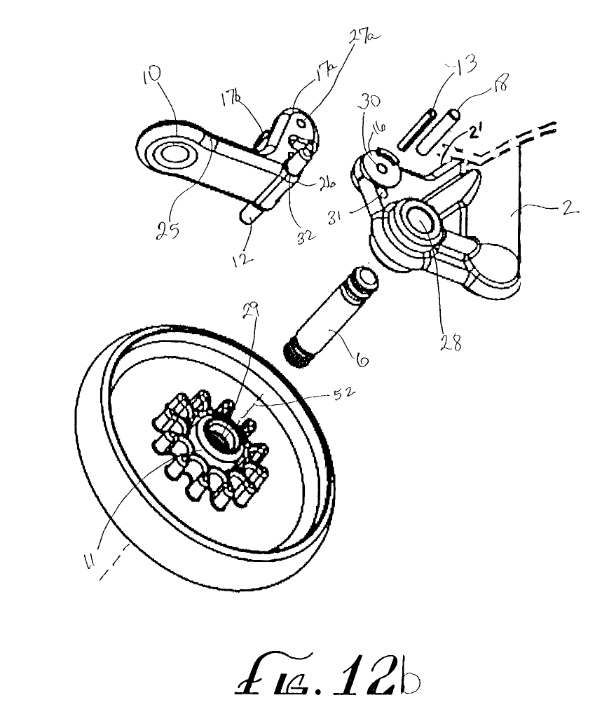

As shown in FIGS. 5 and 7, adjacent to an inner surface of each wheel 3 and 4 is a cogwheel 11, comprising a plurality of radially outwardly extending cogs 14, wherein each pair of adjacent cogs 14 defines a recess 15 therebetween. As best depicted in FIGS. 11a, 11b, 12a and 12b, it is preferred that the cogs 14 extend radially outward from a central axis 52 and a hub 29 of each wheel 3 and 4. As depicted in FIGS. 5-8, a brake lever 10 is mounted to an attachment assembly 2′. The attachment assembly 2′ may either be mounted to the caster body 2 or integrally formed therewith. As depicted in FIGS. 9-12, the brake lever 10 has a brake lever arm 25 and at least one forward jutting projection referred to herein as brake lever mounting hand 17, preferably the brake lever 10 has two forward jutting projections, or brake lever mounting hands 17a and 17b.

In a preferred embodiment, the brake lever 10 is rotatably mounted on the attachment assembly 2′. For example, the brake lever 10 may be rotatably mounted on the attachment assembly 2′ by inserting a dowel pin 13 through an opening in the at least one brake lever mounting hand 17 and through an opening 30 in a brake lever mounting portion 16 of the attachment assembly 2′. Preferably, the dowel pin 13 is composed of a rigid material, such as a metal, for example steel. In the depicted embodiment, the dowel pin 13 is inserted through openings 27a and 27b of the brake lever mounting hands 17a and 17b, respectively, and through the opening 30 in the brake lever mounting portion 16 of the attachment assembly 2′. The dowel pin 13 and the openings 27a, 27b and 30 may be dimensioned to allow the dowel pin 13 to be press fit into the openings 27a, 27b and 30, such that a rotatable coupling is established between the brake lever 10 and the brake lever mounting portion 16 of the attachment assembly 2′.

As shown in FIG. 9, each brake lever mounting hand 17a and 17b comprises a finger 23, a forward jutting projection or locking thumb 24, and another forward jutting projection or braking thumb 26. Disposed between the finger 23 and the locking thumb 24 is a slot 33. In addition, the breaking thumb 26 may comprise an opening 32 through which a braking dowel pin 12 may be inserted. The breaking dowel pin 12 may be mounted to the braking thumb 26 by pressing fitting the braking dowel pin 12 into the opening 32. Preferably, the breaking dowel pin 12 extends from opposing sides on the braking thumb 26. The breaking dowel pin 12 may be composed of a rigid material, such as a metal, for example steel. Alternatively, the breaking dowel pin 12 may be integrally formed with the brake lever 10.

As shown in FIG. 11a, the brake lever mounting portion 16 of the attachment assembly 2′ comprises a flange 50 extending outward from each side the brake lever mounting portion 16 of the attachment assembly 2′. Preferably each flange 50 is disposed on an upper portion of the brake lever mounting portion 16 of the attachment assembly 2′. In a preferred embodiment, each flange 50 fits in a mating recessed portion 51 of a corresponding one of the brake lever mounting hands 17a and 17b to define a maximum upward movement of the brake lever 10 when the brake lever 10 is in the unlocked position.

As best depicted in FIGS. 11a, 11b, 12a, and 12b, the hub 29, which may be located in the center of each wheel 3 and 4, is rotatably coupled with an end of the axle 6, the axle 6 also being coupled to the attachment assembly 2′, for example through bore 28.

In the depicted embodiment of FIG. 9, each brake lever mounting hand slot 33 comprises an upper surface having a convex surface 19 and a downward pointing tip 20; and a lower surface having a concave surface 22 and an upward pointing tip 21.

As depicted in FIGS. 9 and 10, the attachment assembly 2′ comprises a locking dowel pin 18. Preferably, the locking dowel pin 18 is composed of a rigid material, such as a metal, for example steel. As best depicted in FIGS. 11a, 11b, 12a and 12b, the locking dowel pin 18 may be press fit into a bore 31 in the attachment assembly 2′.

In a preferred embodiment, the brake lever 10 is composed of a semi-flexible or elastic material, such as polypropylene or nylon. As a result, the locking thumb 24 of each brake lever mounting hand 17 is semi-flexible.

As previously discussed, and as shown in FIG. 10, each brake lever mounting hand slot 33 comprises a downward pointing upper tip 20 and an upper pointing lower tip 21. The distance between the upper and lower tips 20 and 21, defines an opening 34. In a preferred embodiment, the opening 34 is slightly less than the diameter of the locking dowel pin 18, which is attached to the attachment assembly 2′. Due to the opening 34 being smaller than the diameter of the locking dowel pin 18, in a brake lever 10 resting or unlocked position 10U, the locking dowel pin 18 rests against the upper and lower tips 20 and 21 of the brake lever mounting hand slot 33 and is prevented from entering slot 33.

To move the braking lever from the unlocked position 10U to an active or locked position 10L, an appropriate downward force is applied to the brake lever arm 25. This downward force causes the locking dowel pin 18 to press against and separate the upper and lower tips 20 and 21 to form an opening between the tips 20 and 21 that is larger than the diameter of the locking dowel pin 18, thus allowing the locking dowel pin 18 to enter the lever mounting hand slot 33. When the locking dowel pin 18 is within the slot 33, the locking down pin 18 no longer presses against the upper and lower tips 20 and 21, allowing the tips 20 and 21 to return their original position, once again forming the opening 34 which is less than the diameter of the locking dowel pin 18. As a result, the tips 20 and 21 prevent the locking dowel pin 18 from exiting the slot 33. When the locking dowel pin 18 is within the slot 33, the brake lever 10 is in the locked position 10L.

As the braking lever 10 is moved from the unlocked position 10U to the locked position 10L, causing the locking dowel pin 18 to enter the brake lever mounting hand slot 33, the braking dowel pin 12 is simultaneously moved into engagement with one of the cog recesses 15 formed between the cogs 14. The engagement of the braking dowel pin 12 into the recess 15 between the cogs 14 prevents rotational movement of the wheels 3 and 4 (or in a single wheel, prevents the movement of the wheel 3).

To move the braking lever 10 from the locked position 10L to the unlocked position 10U, an appropriate upward force is applied to the brake lever arm 25. This upward force causes the locking dowel pin 18 to press against and separate the upper and lower tips 20 and 21 to form the opening between the tips 20 and 21 that is larger than the diameter of the locking dowel pin 18, thus allowing the locking dowel pin 18 to exit the lever mounting hand slot 33. After the locking dowel pin 18 has exited the slot 33, the locking down pin 18 no longer presses against the upper and lower tips 20 and 21, allowing the tips 20 and 21 to return their original position, once again forming the opening 34 which is less than the diameter of the locking dowel pin 18. Therefore, the tips 20 and 21 again prevent the locking dowel pin 18 from entering the slot 33, and the braking lever is again in the unlocked position 10U.

As the braking lever 10 is moved from the locked position 10L to the unlocked position 10U, causing the locking dowel pin 18 to exit the brake lever mounting hand slot 33, the braking dowel pin 12 is simultaneously moved out of engagement with the cog recess 15 and the wheels 3 and 4 are again able to rotate.

Although the present invention has been described and illustrated with respect to a preferred embodiments thereof, it is to be understood that the invention is not to be limited since changes and modifications are within the intended scope of the invention as hereinafter claimed.

What is claimed is:

1. A caster assembly comprising:
at least one caster wheel;
a wheel axis attached to the at least one caster wheel;
a caster body having an attachment assembly, wherein the wheel axis is attached to the attachment assembly;
a cogwheel attached to each of the at least one caster wheels, wherein each cogwheel has a plurality of radially outwardly extending cogs and a plurality of cog recesses, wherein each pair of adjacent cogs defines a cog recess therebetween; and
a brake lever arm moveably attached to the attachment assembly, such that the brake lever arm is moveable between a locked position, wherein the brake lever arm prevents a rotation of the at least one caster wheel and an unlocked position, wherein the brake lever arm does not prevent a rotation of the at least one caster wheel, the brake lever arm having a protrusion for engagement with a corresponding one of the plurality of cog recesses, such that when the protrusion is engaged with the corresponding one of the plurality of cog recesses, the brake lever arm is in the locked position and when the protrusion is not engaged with the corresponding one of the plurality of cog recesses, the brake lever arm is in the unlocked position.

2. The caster assembly of claim 1, further comprising a locking element attached to the attachment assembly, wherein the locking element hinders a disengagement of the protrusion with the corresponding one of the plurality of cog recesses when the brake lever arm is in the locked position, and wherein the locking element hinders an engagement of the protrusion with the corresponding one of the plurality of cog recesses when the brake lever arm is in the unlocked position.

3. The caster assembly of claim 1, wherein the brake lever arm comprises a slot having a downward pointing upper tip and an upward pointing lower tip, such that an opening formed between the upper and lower tips is smaller than the locking element, wherein the opening formed between the upper and lower tips hinders a disengagement of the protrusion with the corresponding one of the plurality of cog recesses when the brake lever arm is in the locked position, and wherein the opening formed between the upper and lower tips hinders an engagement of the protrusion with the corresponding one of the plurality of cog recesses when the brake lever arm is in the unlocked position.

4. The caster assembly of claim 3, wherein the downward pointing upper tip and the upward pointing lower tip of the brake lever arm slot are each composed of an elastic material, such that the opening formed between the upper and lower tips is expandable.

5. The caster assembly of claim 1, wherein the locking element is a dowel pin.

6. The caster assembly of claim 5, wherein the dowel pin is composed of a rigid material.

7. The caster assembly of claim 1, wherein the brake lever arm protrusion is a dowel pin.

8. The caster assembly of claim 1, wherein the brake lever arm is rotatably attached to the attachment assembly.

9. A caster assembly comprising:
at least one caster wheel;
a wheel axis attached to the at least one caster wheel;
a caster body having an attachment assembly, wherein the wheel axis is attached to the attachment assembly;
a cogwheel attached to each of the at least one caster wheels, wherein each cogwheel has a plurality of radially outwardly extending cogs and a plurality of cog recesses, wherein each pair of adjacent cogs defines a cog recess therebetween;
a brake lever arm pivotably attached to the attachment assembly, such that the brake lever arm is pivotable between a locked position, wherein the brake lever arm prevents a rotation of the at least one caster wheel and an unlocked position, wherein the brake lever arm does not prevent a rotation of the at least one caster wheel, the brake lever arm having a protrusion for engagement with a corresponding one of the plurality of cog recesses, such that when the protrusion is engaged with the corresponding one of the plurality of cog recesses, the brake lever arm is in the locked position and when the protrusion is not engaged with the corresponding one of the plurality of cog recesses, the brake lever arm is in the unlocked position; and
a locking element attached to the attachment assembly, wherein the locking element hinders a disengagement of the protrusion with the corresponding one of the plurality of cog recesses when the brake lever arm is in the locked position, and wherein the locking element hinders an engagement of the protrusion with the corresponding one of the plurality of cog recesses when the brake lever arm is in the unlocked position.

10. The caster assembly of claim 1, wherein the brake lever arm comprises a slot having a downward pointing upper tip and an upward pointing lower tip, such that an opening formed between the upper and lower tips is smaller than the locking element, wherein the opening formed between the upper and lower tips hinders a disengagement of the protrusion with the corresponding one of the plurality of cog recesses when the brake lever arm is in the locked position, and wherein the opening formed between the upper and lower tips hinders an engagement of the protrusion with the corresponding one of the plurality of cog recesses when the brake lever arm is in the unlocked position.

11. The caster assembly of claim 10, wherein the downward pointing upper tip and the upward pointing lower tip of the brake lever arm slot are each composed of an elastic material, such that the opening formed between the upper and lower tips is expandable.

12. The caster assembly of claim 9, wherein the locking element is a dowel pin.

13. The caster assembly of claim 12, wherein the dowel pin is composed of a rigid material.

14. The caster assembly of claim 1, wherein the brake lever arm protrusion is a dowel pin.

15. A caster assembly comprising:
at least one caster wheel;
a wheel axis attached to the at least one caster wheel;
a caster body having an attachment assembly, wherein the wheel axis is attached to the attachment assembly;
a locking element attached to each of the at least one caster wheels; and
a braking assembly attached to the attachment assembly, such that when the braking assembly is interlockingly coupled to the locking element, rotation of the at least one caster wheel is prevented.

16. The caster assembly of claim 15, wherein the braking assembly is pivotably attached to the attachment assembly.

17. The caster assembly of claim 15, wherein the locking element has a recess and the braking assembly has a protrusion, such that the when the protrusion is interlockingly engaged with the recess, rotation of the at least one caster wheel is prevented.

18. The caster assembly of claim 17, wherein the locking element is a cogwheel.

19. The caster assembly of claim 18, wherein cogwheel has a plurality of radially outwardly extending cogs and a plurality of cog recesses, wherein each pair of adjacent cogs defines a cog recess therebetween for interlocking engagement with the braking assembly.

20. The caster assembly of claim 19, wherein braking assembly is a brake lever arm having a protrusion for engagement with a corresponding one of the plurality of cog recesses, such that when the protrusion is interlockingly engaged with the corresponding one of the plurality of cog recesses, rotation of the at least one caster wheel is prevented.
